(19) United States
(12) Patent Application Publication
(10) Pub. No.: US 2004/0107942 A1
(43) Pub. Date: Jun. 10, 2004

(54) Internally pressurized component with a variable inner diameter for fuel injection for internal combustion engines

(76) Inventor: Markus Degn, Altmuenster (AT)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/682,482

(22) Filed: Oct. 10, 2003

(30) Foreign Application Priority Data
Oct. 10, 2002 (DE) 102 47 323.4

(51) Int. Cl. F02M 1/00

(52) U.S. Cl. 123/447; 123/456

(57) ABSTRACT

The invention relates to an internally pressurized component, the inside of which contains a bore extending in its longitudinal direction, which has a number of connecting parts. In order to permit the geometry of the bore to be optimized, the cross section of the bore is non-cylindrical in a middle part and has a cylindrical cross section in at least one end region of the end parts, wherein the cross section of the middle part transitions continuously into the cross section of the end part.

### BACKGROUND OF THE INVENTION

1. Field of the Invention

The invention relates to an internally pressurized component, in particular to serve as a high-pressure fuel reservoir for fuel injection systems in internal combustion engines having a high-pressure fuel pump suitable for supplying fuel to the high-pressure fuel reservoir, wherein the high-pressure fuel reservoir is comprised of an elongated, tubular body with an internal bore that is adjoined by at least one bore for inflow and outflow.

2. Description of the Prior Art

In the field of injection engineering, internally pressurized components are essential to the injection of fuel in internal combustion engines, particularly in so-called common rail injection systems. In this field, such components are used for high-pressure reservoirs (rails) and injectors. These components of the fuel injection system not only experience very high internal pressures, but are also subjected to periodically powerful fluctuations in the internal pressure (so-called swelling internal pressure). As a result, components must meet correspondingly high strength requirements, chiefly with respect to the strength of the bore intersections inside the high-pressure reservoir.

### OBJECT AND SUMMARY OF THE INVENTION

The object of the invention is to achieve a geometric optimization of the high-pressure reservoir (rail) so that in particular, the sealing force at the end of the high-pressure reservoir is reduced, but without changing the functionally optimized geometry of the high-pressure reservoir.

The essence of the invention lies in the fact that while the rest of the cross section is non-cylindrical, at least one end section of the internally pressurized component has a cylindrical cross section, particularly in the part that contains bore intersections or that contains only the accumulator part.

An essential advantage of the invention lies in the fact that in a particular section of the internally pressurized component, the cross section of the longitudinally extending internal bore can be embodied arbitrarily, without requiring changes to be made to the connecting and sealing systems known from the prior art.

Another advantage lies in the fact that as opposed to the non-cylindrical cross section in the central part of the component, the cylindrical cross sections in the end regions of the internally pressurized component permit a circular seal (axial or radial) to be produced using conventional methods. In addition, the sealing diameter can also be minimized, which allows the sealing forces to also be correspondingly minimized. This offers the possibility of embodying the ends of the internally pressurized component independently of the dimensions of the actual bore of the internally pressurized component.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a cross section through an internally pressurized component (rail);

FIG. 2 shows a cross section through the component according to FIG. 1, along a line II-II;

FIG. 3 shows a cross section through the component according to FIG. 2, along a line III(1)-III(1) and III(2)-III(2);

FIG. 4 shows a cross section through an alternative embodiment of the component according to FIG. 1, in this case with a connecting element that is forged onto the component; and

FIG. 5 shows a cross section through the component according to FIG. 3, along a line III(1)-III(1) and III(2)-III(2).

### DESCRIPTION OF THE PREFERRED EMBODIMENTS

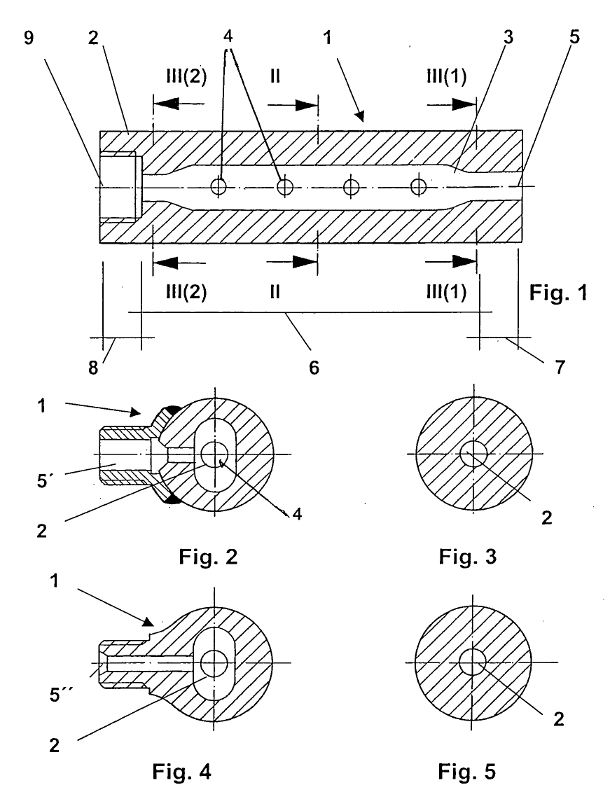

FIG. 1 shows a cross section through an internally pressurized component 1, which has an arbitrary outer contour 2. The bore 3 contained in the component 1 extends in the longitudinal direction of the component 1 and passes all the way through it. In addition, this bore is connected to additional bores 4, that are routed through connecting parts 5′ and 5″, as shown in FIG. 2 and FIG. 4.

According to the invention, the bore 3 has different cross sections, the cross section of the component 1 being non-cylindrical in the middle part 6 (see FIG. 2 and FIG. 4). In the end regions 7 and 8, however, the cross section is cylindrical (see FIG. 3 and FIG. 5); the cross-section changes continuously (within the limits of manufacturability) from the middle part 6 to the end regions 7 and 8. This continuous change is essential in order to prevent corresponding stress concentrations or peaks.

In addition, the end regions 7, 8 are provided with adapter parts 9, which are for accommodating an add-on component that is not shown in detail in the drawing. In the exemplary embodiment shown in FIG. 1, the adapter part 9 and the component 1 are of one piece.

The variable cross section of the bore 3 of the component 1 is completely independent of the outer contour 2, thus allowing the connecting parts 5′ to be welded on, as shown in FIG. 2, or, as shown in FIG. 4, allowing the connecting parts 5 to be forged on or as an integral part of component 1.

The invention can be used on all internally pressurized components, in particular common rails, injectors, pumps, or the like.

The foregoing relates to preferred exemplary embodiments of the invention, it being understood that other variants and embodiments thereof are possible within the spirit and scope of the invention, the latter being defined by the appended claims.

I claim:

1. In internally pressurized component, in particular to serve as a high-pressure fuel reservoir for fuel injection in internal combustion engines, having a high-pressure fuel pump suitable for supplying fuel to the high-pressure fuel reservoir, wherein the high-pressure fuel reservoir is comprised of an elongated, tubular body with an internal bore and connections to bores for inflow and outflow, the improvement wherein at least one section of the internally pressurized component (1) has a non-cylindrical cross section.

2. The component according to claim 1, wherein at least one end region (7, 8) of the component (1) has a cylindrical cross section.

3. The component according to claim 1, wherein the transition from the non-cylindrical cross section to the cylindrical cross section occurs continuously.

4. The component according to claim 2, wherein the transition from the non-cylindrical cross section to the cylindrical cross section occurs continuously.

5. The component according to claim 1, wherein at least one end region (7, 8) of the component (1) comprises an adapter part (9) for accommodating an add-on component.

6. The component according to claim 2, wherein at least one end region (7, 8) of the component (1) comprises an adapter part (9) for accommodating an add-on component.

7. The component according to claim 3, wherein at least one end region (7, 8) of the component (1) comprises an adapter part (9) for accommodating an add-on component.

8. The component according to claim 4, wherein at least one end region (7, 8) of the component (1) comprises an adapter part (9) for accommodating an add-on component.

9. The component according to claim 1, wherein the adapter part and component are of one piece.

10. The component according to claim 2, wherein the adapter part and component are of one piece.

11. The component according to claim 3, wherein the adapter part and component are of one piece.

12. The component according to claim 5, wherein the adapter part and component are of one piece.
